(19) United States
(12) Patent Application Publication
(10) Pub. No.: US 2023/0391966 A1
(43) Pub. Date: Dec. 7, 2023

(54) Capacitor containing a biaxially oriented polypropylene-cyclic olefin polymer film as a dielectric, and use of said film

(71) Applicant: Topas Advanced Polymers GmbH, Raunheim (DE)

(72) Inventor: Wolfram Goerlitz, Wiesbaden (DE)

(21) Appl. No.: 18/031,828

(22) PCT Filed: Sep. 28, 2021
(86) PCT No.: PCT/EP2021/000113

§ 371 Date: Jun. 13, 2023

(30) Foreign Application Priority Data
Oct. 27, 2020 (DE) 102020006588.0
Sep. 28, 2021 (WO) PCT/EP2021/000113

(51) Int. Cl. C08J 5/18; C08L 23/12

(52) U.S. Cl. CPC C08J 5/18; C08L 23/12; C08J 2323/12; C08J 2445/00

(57) ABSTRACT

Disclosed are capacitors containing as dielectric a biaxially oriented film comprising a mixture of polypropylene and cycloolefin polymer, the proportion of cycloolefin polymer in the mixture being between 3 and 18% by weight.

These capacitors are characterized by high temperature resistance and high dielectric strength at room temperature.

The present invention concerns capacitors containing selected biaxially oriented polypropylene films with small additions of cycloolefin polymer as dielectric.

Biaxially oriented PP films (BOPP films) for use as dielectric in capacitors are described in several patent documents, for example in WO 2015/091829 A1, U.S. Pat. No. 5,724,222 A and EP 2 481 767 A2. Biaxially oriented polyolefin films containing cycloolefin polymers are known from WO 2018/197034 A1.

BOPP films and biaxially oriented polyolefin films containing cycloolefin polymers have excellent electrical and mechanical properties. The latter are characterized by increased resistance at temperatures above 100° C. and low thermal shrinkage.

From WO 2018/197034 A1, polyolefin films are known which can preferably be used as capacitor films and which are characterized by an increased resistance of the electrical properties and by a low shrinkage at elevated temperatures. The films described in the examples of this document have a cycloolefin copolymer content of at least 20% by weight.

WO 2018/210854 A1 describes capacitors with films of polypropylene and cycloolefin copolymers that are characterized by increased resistance of electrical properties at elevated temperatures. The capacitor films described in this document have a cycloolefin copolymer content of at least 20% by weight. Additional properties of such films are reported in a paper by W. Goerlitz, A New Approach for High Temperature Polypropylene Film Capacitors, in Research Disclosure Journal, November 2018, DB no. 655030.

In the case of previously known films made from polypropylene and cycloolefin copolymers, it was assumed that relatively high amounts of cycloolefin copolymer were required to achieve improved properties. These publications speak of at least 10 wt %, preferably 20-30 wt %.

A disadvantage that becomes apparent when reviewing the available literature is the fact that such films exhibit reduced breakdown voltage at room temperature compared to films made from pure polypropylene.

Surprisingly, it was found that polypropylene films show improved properties when they have a low content of cycloolefin polymers. This is not obvious, since those skilled in the art previously assumed that a higher content of cycloolefin polymer was required for improved thermal properties, with the disadvantage of lower breakdown voltages.

One objective of the present invention is to provide capacitors which, in addition to excellent thermal resistance, have a high breakdown voltage.

Another objective of the present invention is to provide polypropylene films with excellent thermal resistance and high breakdown voltage, which can be produced on conventional equipment for OPP production.

Still another objective of the present invention is to provide polypropylene films that are closer in important properties to known OPP capacitor films than PP/COC films previously proposed for use in capacitors.

The present invention concerns capacitors containing as dielectric a biaxially oriented film comprising a blend of polypropylene and cycloolefin polymer, with the proviso that the proportion of cycloolefin polymer in the blend is between 3 and 18% by weight.

The polypropylene film used according to the invention contains a blend of polypropylene and a small proportion, i.e. between 3 and 18% by weight, of cycloolefin polymer. The percentage refers to the total mass of the mixture of polypropylene and cycloolefin polymer.

Preferably, the proportion of cycloolefin polymer in the blend is between 3 and 14% by weight, more preferably between 4 and 14% by weight, in particular between 5 and 14% by weight, very preferably between 6 and 12% by weight, and especially preferred between 7 and 9% by weight.

The polypropylene films used according to the invention are characterized by a better homogeneity of the polymer matrix and the surface in comparison with polypropylene films containing an increased proportion of cycloolefin polymer. Polypropylene films used according to the invention thus come closer in important properties to known OPP capacitor films than PP/COC films proposed so far for use in capacitors.

The improved homogeneity of the polypropylene films used according to the invention can be demonstrated by scanning electron microscopy.

The improved surface structure of the polypropylene films used according to the invention can be demonstrated by light microscopic examinations.

For scanning electron microscopic examinations, a film is cut with a microtome. The sections obtained are then brought into contact with cyclohexane at room temperature for 24 hours. This removes the cycloolefin polymer phases from the film and these areas appear dark in the scanning electron microscope examination.

The polypropylene films used according to the invention which have been treated with cyclohexane show no phase structure in the scanning electron microscopic examination, while polypropylene films with an increased proportion of cycloolefin polymer show separate phases of cycloolefin polymer.

For the purposes of this description, the term “no phase structure” is to be understood as meaning that no dark structures are visible in the scanning electron microscopic examination of films treated with cyclohexane at a resolution of 0.1 μm, which would indicate the presence of cycloolefin polymer phases.

For further investigations, the surface of a film is observed with an optical microscope. Polypropylene films used according to the invention show surface structures which are typical for OPP capacitor films. Irregular line patterns can be seen, with the longitudinal dimensions of individual lines being up to 100 μm. In contrast, polypropylene films with an increased proportion of cycloolefin polymer show clearly fibrillar surface structures. Here, structures run parallel to each other, and the longitudinal dimensions of individual structures can be several millimeters.

Films used according to the invention thus show a surface structure without fibrils in the light microscopic examination.

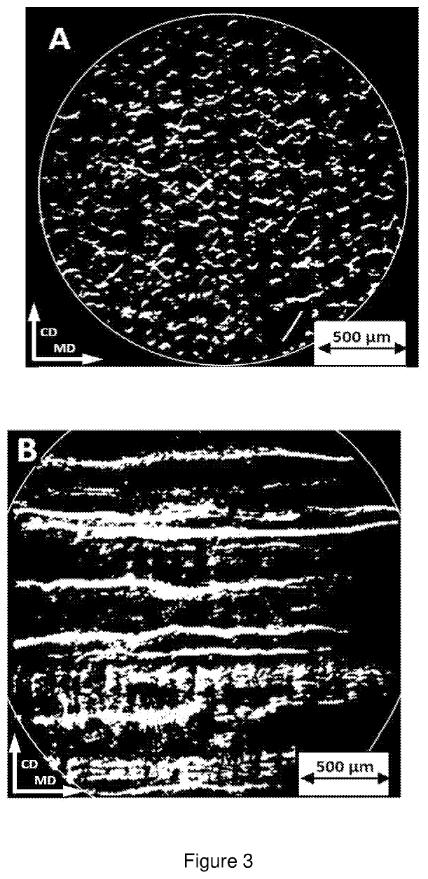

For the purposes of this description, the term “without fibrils” means that no parallel structures extending beyond 1 mm are visible in the light microscopic examination of the film surface. This can be seen as an example in FIG. 3A; while FIG. 3B shows a fibrillar surface structure of a conventional film made from PP/COC blends. The following imaging conditions were used: Stereomicroscope, numerical aperture 0.2, incident light oblique, field of view approx. 2 mm, magnification 64×).

The cycloolefin polymers used according to the invention are polymers known per se. They may be polymers derived from one monomer or from two or more different monomers.

The cycloolefin polymers are prepared by ring-opening or, in particular, ring-maintaining polymerization, preferably by ring-maintaining copolymerization of cyclic olefins, such as norbornene, with non-cyclic olefins, such as alpha-olefins, in particular ethylene.

The choice of catalysts can be used to control, in a manner known per se, whether the olefinic ring of the cyclic monomer is retained or opened during polymerization. Examples of ring-opening polymerization processes for cycloolefins can be found in EP 0 827 975 A2. Examples of catalysts mainly used in ring-preserving polymerization are metallocene catalysts. An overview of possible chemical structures of polymers derived from cycloolefins can be found, for example, in Pure Appl. Chem., Vol. 77, No. 5, pp. 801-814 (2005).

In the context of this description, the term “cycloolefin polymer” also refers to polymers which have been subjected to hydrogenation after polymerization in order to reduce any double bonds still present.

The cycloolefin polymers used according to the invention are thermoplastics which are characterized by an extraordinarily high transparency.

The glass transition temperature (hereinafter also referred to as “T g”) of cycloolefin polymers can be adjusted by the skilled person in a manner known per se by selecting the type and amount of monomers, e.g. the type and amount of cyclic and non-cyclic monomers. For example, it is known from norbornene-ethylene copolymers that the higher the proportion of norbornene component in the copolymer, the higher the glass transition temperature. The same applies to combinations of other cyclic monomers with non-cyclic monomers.

In the context of the present description, glass transition temperature means the temperature determined according to ISO 11357 by the differential scanning calorimetry (DSC) method, the heating rate being 10 K/minute.

In the polymer films used according to the invention, cycloolefin polymers with glass transition temperatures greater than 30° C. can be used. Preferably, the glass transition temperatures are 100 to 170° C., more preferred 120 to 165° C., still more preferred 130 to 160° C., even more preferred 140 to 160° C. and most preferred greater than 145 to 160° C.

In another preferred embodiment of the polymer film used according to the invention, cycloolefin copolymers are employed which are derived from the ring-maintaining copolymerization of at least one cycloolefin of the general formula (I) with at least one alpha-olefin of the formula (II)

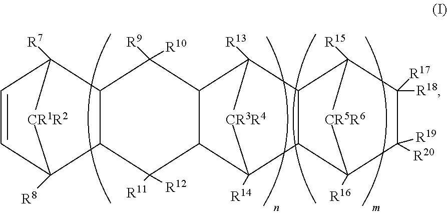

wherein
n is 0 or 1
m is 0 or a positive integer, in particular 0 or 1,
R¹, R², R³, R⁴, R⁵, R⁶ independently of one another denote hydrogen, halogen, alkyl groups, cycloalkyl groups, aryl groups and alkoxy groups
R⁷, R⁸, R⁹, R¹⁰, R¹¹, R¹², R¹³, R¹⁴, R¹⁵, R¹⁶ independently of one another denote hydrogen and alkyl groups
R¹⁷, R¹⁸, R¹⁹, R²⁰ independently of one another denote hydrogen, halogen and alkyl groups,
where R¹⁷ and R¹⁹ can also be bonded to one another in such a way that they form a single ring or a ring system with several rings, where the ring or rings can be saturated or unsaturated,

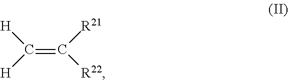

wherein R²¹ and R²² are independently of one another hydrogen and alkyl groups.

In a particularly preferred embodiment, cycloolefin copolymers are used which are derived from compounds of the formulae I and II in which n is 0, m is 0 or 1, R²¹ and R²² are both hydrogen or R²¹ is hydrogen and R²² is an alkyl group having from one to eight carbon atoms, and R¹, R², R⁵ to R⁸ and R¹⁵ to R²⁰ are preferably hydrogen.

In a very particularly preferred embodiment, cycloolefin copolymers are used which are derived from compounds of the formulae I and II in which the compound of the formula I is norbornene or tetracyclododecene and the compound of the formula II is ethylene.

Very preferably, copolymers of the type defined above are used, the copolymerization of which has been carried out in the presence of a metallocene catalyst.

Preferred grades of cycloolefin copolymers are described in DE 102 42 730 A1. Particularly preferred cycloolefin copolymers are Topas® 6013, Topas® 6015 and Topas® 5013 (Topas Advanced Polymers GmbH, Raunheim).

Blends of different cycloolefin polymers can also be used, in particular blends of different cycloolefin copolymers.

The cycloolefin copolymers preferably used according to the invention are prepared by ring-preserving polymerization, i.e. the bi- or polycyclic structure of the monomer units used is retained during polymerization. Examples of catalysts are titanocene, zirconocene or hafnocene catalysts, which are usually used in combination with aluminoxanes as co-catalysts. This production method has already been described many times, for example in the patent document mentioned above.

Typical examples of cycloolefin copolymers are copolymers of norbornene or tetracyclododecene with ethylene. Such polymers are commercially available, for example under the trade names APEL® or TOPAS®.

Other examples are cycloolefin polymers derived from ring-opening polymerization of cyclopentadiene or of norbornene. Such polymers are also commercially available, for example under the trade names ARTON®, ZEONEX® or ZEONOR®.

Cycloolefin copolymers derived from the monomers of the formulae I and II described above are preferably used, these monomers I:II having been used in a molar ratio of 95:5 to 5:95 and these copolymers optionally still containing small proportions of structural units, for example up to 10 mol %, based on the total amount of monomers, which are derived from further monomers, such as propylene, pentene, hexene, cyclohexene and/or styrene.

Particularly preferred are cycloolefin copolymers which consist essentially of norbornene and ethylene and which may also contain small amounts, e.g. up to 5% by weight, based on the total amount of monomers, of structural units derived from other monomers such as propylene, pentene, hexene, cyclohexene and/or styrene.

Other particularly preferred cycloolefin polymers have a melt flow index of between 0.3-4 g/10 minutes, measured at a temperature of 230° C. under a load of 2.16 kg.

As the main component, the film used according to the invention contains one or more polypropylenes. These are essentially propylene homopolymers or copolymers. They may be semicrystalline propylene homopolymers, which preferably have a crystallite melting temperature of 160 to 165° C., and/or semicrystalline propylene-C₄-C₈-alpha-olefin copolymers, which preferably have a crystallite melting temperature of 100 to 160° C.

In the context of the present description, crystallite melting temperature means the temperature determined according to ISO 11357 by the differential scanning calorimetry (DSC) method, the heating rate being 20 K/minute.

Examples of C₄-C₈ alpha-olefins are butene-1, hexene-1 and octene-1.

The polypropylenes are linear or branched types. The sequence of different monomer units in these polypropylenes can be random or in the form of blocks. The individual monomer units can be arranged in sterically different ways, for example, isotactically, syndiotactically or atactically.

Polypropylene is an isotactic, syndiotactic or atactic polypropylene produced with the aid of stereospecifically acting catalysts. The isotactic polypropylene, in which all the methyl groups are arranged on one side of the imaginary zigzag molecular chain, is particularly preferred as the main component in the films used according to the invention.

When cooling from the melt, the regular structure of the isotactic polypropylene favors the formation of crystalline regions. However, the chain molecules are rarely incorporated into a crystallite in their entire length, since they also contain non-isotactic and thus non-crystallizable portions. In addition, amorphous regions are formed by the entanglement of the chains in the melt, especially at a high degree of polymerization. The crystalline content depends on the manufacturing conditions of the molded parts and ranges from 50% to 70%. The semi-crystalline structure gives some strength and stiffness due to the high secondary forces in the crystallite; while the disordered regions with the higher mobility of their chain segments above the freezing temperature give flexibility and toughness.

Examples of preferred polypropylenes can be found in WO 2020/127861 A1.

The density of polypropylene is very low, ranging from 0.895 g/cm³ to 0.92 g/cm³. Polypropylene has a glass transition temperature of 0 to −10° C. The crystallite melting range is 160 to 170° C., especially between 160 and 165° C. These temperatures can be modified by copolymerization; the measures for this are known to the skilled person.

Preferred main components of the film used according to the invention are propylene homopolymers, propylene copolymers with 1-10 wt. % of structural units derived from 1-alkenes with 4-8 C atoms, propylene ethylene copolymers with 60 to 90 wt. % of structural units derived from propylene, and combinations of two or more thereof.

Particularly preferred semi-crystalline propylene polymers have a melt flow index of between 2-6 g/10 minutes, preferably between 2 to 5, measured at a temperature of 230° C. under a load of 2.16 kg.

Particularly preferred, the polypropylene film used according to the invention has a low metal content. This is desirable for use as a capacitor film, since even traces of metals in the dielectric can adversely affect the electrical properties of the capacitor.

Preferably, the total content of iron, cobalt, nickel, titanium, molybdenum, vanadium, chromium, copper, magnesium and aluminum in the film used according to the invention is less than 10 ppm.

Preferred are capacitors in which the cycloolefin polymer is a cycloolefin copolymer.

Further preferred are capacitors in which the cycloolefin polymer has a glass transition temperature between 130 and 170° C., preferably between greater than 145 and 160° C.

Very particularly preferred are capacitors in which the cycloolefin polymer is a cycloolefin copolymer consisting of structural units derived from ethylene and norbornene.

Also very particularly preferred are capacitors in which the polypropylene is a propylene homopolymer or a propylene copolymer with other alpha-olefins, in particular a semi-crystalline polypropylene with a crystallite melting temperature between 100 and 170° C., preferably between 150 and 165° C.

Further preferred are capacitors in which the polypropylene is a capacitor-grade polypropylene.

Also preferred are capacitors in which the biaxially oriented film is metallized.

Particularly preferred are capacitors in which the biaxially oriented film contains no additives.

Particularly preferred are capacitors in which the total content of iron, cobalt, nickel, titanium, molybdenum, vanadium, chromium, copper, magnesium and aluminum in the biaxially oriented film is less than 10 ppm.

The thickness of the polypropylene films used in accordance with the invention can vary over a wide range. Typical thicknesses are in the range from 0.5 to 50 μm, in particular between 0.5 and 20 μm, and very preferred between 1 and 15 μm. The thickness of the molded article is determined according to DIN 53370.

The polypropylene blends used in the capacitors according to the invention can basically be produced by mixing the individual components in devices suitable for this purpose. Mixing can advantageously be carried out in kneaders, rolling mills or extruders.

The amount of cycloolefin polymer in the polypropylene blend is from 3 to 18 wt. %, based on the total blend, preferably between 3 and 14 wt. %, more preferred between 4 and 14 wt. %, especially between 5 and 14 wt. %, most preferred between 6 and 12 wt. %, and very most preferred between 7 and 9 wt. %.

The amount of polypropylene in the polymer blend is typically between 97 and 82 wt. %, based on the total blend, preferably between 97 and 86 wt. %, more preferred between 96 and 86 wt. %, in particular between 95 and 86 wt. %, most preferred between 94 and 88 wt. %, and very most preferred between 93 and 91 wt. %.

In addition to the obligatory cycloolefin polymer and the polypropylene, the polymer blend may also contain additives that are customary per se. The total proportion of these additives is usually up to 5% by weight, based on the total blend, preferably up to 2% by weight and in particular up to 1% by weight.

Additives, also called adjuvants or auxiliary materials, are substances which are added to the polymer blend in small quantities in order to achieve or to improve certain properties, for example to achieve a positive effect on production, storage, processing or product properties during and after the use phase.

The additives may be processing aids, such as oils or waxes, or additives which impart a specific function to the polymer blend or the polyolefin film used according to the invention, such as plasticizers, UV stabilizers, matting agents, preservatives, biocides, antioxidants, antistatics, flame retardants, reinforcing agents, fillers, pigments, dyes or other polymers.

The polypropylene film used according to the invention is obtained by thermoforming the polymer blend described above. The manufacturing conditions and equipment known in the production of OPP films can be used. This is of great advantage, since the process can be carried out on existing equipment and using known process parameters. The extruded film is biaxially stretched and optionally relaxed (thermally fixed).

In biaxial stretching, the preformed and stretchable film can be stretched simultaneously in the longitudinal and transverse directions, or the stretching can be performed sequentially in any order (e.g., first in the longitudinal direction and then in the transverse direction). In addition, stretching can be performed in a single step or in multiple steps. The manufacturing conditions, in particular the stretching conditions, are oriented towards the usual known conditions for industrially produced biaxially oriented polypropylene films.

The stretching ratio in the machine direction is generally at least 1:2, preferably at least 1:3 and in particular 1:3 to 1:8. The stretching ratio transverse to the machine direction is generally at least 1:5, preferably at least 1:8 and very particularly preferred 1:8 to 1:12.

The stretched film can be thermally fixed after stretching. This achieves particularly high dimensional stability at high temperatures. The thermal fixation can be carried out by conventional processes.

According to the invention, coextruded multilayer films can also be used. These may be multilayer films in which several of the polypropylene films described above are combined. However, they may also be multilayer films in which one or more of the polypropylene films described above are combined with other films.

Preferably, polypropylene films are single-layered or 2-, 3-, 4- or 5-layered, whereby multilayered polypropylene films contain at least one of the polypropylene films described above.

The polypropylene films used according to the invention preferably have electrical breakdown strengths as known from conventionally used polypropylene films, preferably electrical breakdown strengths of >500 V/μm, measured according to DIN EN 60243-2 under DC voltage at 23° C. and using a circular electrode with a diameter of 50 mm.

The polypropylene films used in accordance with the invention also preferably have a dielectric loss factor of less than or equal to 0.002, measured at a frequency in the range of 1 kHz and 1 GHz at a temperature of 25° C.

The capacitors according to the invention can be all common types of capacitors. These can be designed for use with alternating current or preferably with direct current. Examples of capacitor types are film capacitors. These are usually wound capacitors, in which either only the metallized foil (the metallized dielectric) or a non-metallized foil (unmetallized dielectric) is wound together with a thin metal foil. A distinction is usually made between film capacitors, round-wound capacitors, flat-wound capacitors and ring capacitors. The standard manufacturing processes of the capacitors are known to the skilled person.

The invention also relates to the use of a biaxially oriented film comprising a blend of polypropylene and cycloolefin polymer, the proportion of cycloolefin polymer in the blend being between 3 and 18% by weight, as a dielectric for capacitors.

The following examples explain the invention without limiting it thereto.

### EXAMPLES V1, V2 AND 1 TO 5

Biaxially stretched films of polypropylene as well as polypropylene-cycloolefin copolymer blends were produced in a thickness of 6 μm and metallized and from these hermetically sealed round wound capacitors were produced.

Electrical breakdown strengths were determined on the films at 23° C. according to DIN EN 60243-2, using DC voltage and a circular electrode with a diameter of 50 mm. Table 1 below gives details of the films and capacitors used and the measurement results.

TABLE 1

| | | | | surface | Electric | |
|---|---|---|---|---|---|---|
| | polymer | | T_{g} | roughness⁵⁾ | breakdown | |
| | composition | | COC | Ra of film | strength³⁾ | capacity⁴⁾ |
| Example | PP(%)¹⁾ COC(%)²⁾ | | [° C.] | [μm] | [V/μm] | [μF] |
| V1 | 100 | 0 | — | 0.08 | 580 | 6.37 |
| 1 | 95 | 5 | 147 | 0.08 | 582 | 6.29 |
| 2 | 93 | 7 | 147 | 0.09 | 577 | 6.26 |
| 3 | 93 | 7 | 142 | 0.08 | 582 | 6.29 |
| 4 | 88 | 12 | 142 | 0.08 | 570 | 6.28 |
| 5 | 85 | 15 | 147 | 0.08 | 579 | 6.27 |
| V2 | 80 | 20 | 142 | 0.08 | 545 | 19.8 |

¹⁾Highly crystalline polypropylene homopolymer. capacitor film grade from Borealis
²⁾Cyclooclefin copolymer from norbornene and ethylene
³⁾Measured values are mean values from 10 individual measurements
⁴⁾Measured values are mean values from 10 individual measurements; measurement at 1 KHz
⁵⁾Surface roughness determined according to DIN 4769

These examples show that PP/COC films of examples 1 to 5 used in accordance with the invention have a better dielectric strength than PP/COC films previously proposed for use in capacitors.

Furthermore, the homogeneity of the polymer matrix and the surface is improved. Films used according to the invention thus come closer in important properties to known OPP capacitor films than PP/COC films proposed so far for use in capacitors.

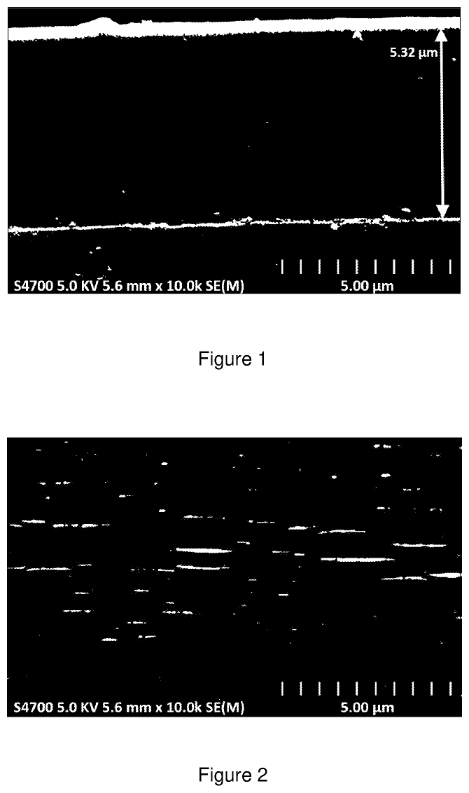

FIG. 1 shows a scanning electron micrograph of a cross-section through a film according to examples V1, 1, 2, 3, 4 and 5. FIG. 2 shows a scanning electron micrograph of a cross-section through a film according to example V2.

To prepare FIGS. 1 and 2, the films were cut with a microtome and COC phases were removed by contact with cyclohexane at room temperature for 24 hours. Areas where polymer has been removed are darkened by this procedure. The scanning electron microscope used was the Hitachi S-4700 model.

From the scanning electron micrographs of the films according to Example V2, it can be seen that the COC is present in the polypropylene matrix as a separate phase. Such COC phases in PP matrices are already known and described in Research Disclosure No. 655030 of November 2018. In contrast, the films of Examples 1 to 5 used according to the invention and the OPP film of Example V1 do not show any visible phase structure (resolution about 0.1 μm).

The upper half of FIG. 3 shows an optical microscope image of the surface of a film according to Example V1, 1, 2, 3, 4 or 5. For these images, the films were not prepared. The films were viewed under oblique incident light illumination or dark field and appropriate magnification. The lower half of FIG. 3 shows an optical microscope image of the surface of a film according to Example V2. Films of examples 1 to 5 used according to the invention show the same surface structures typical for OPP capacitor films. In contrast, films made from PP/COC blends of Example V2 with a higher COC content show a different fibrillar surface structure.

Films used according to the invention thus show a surface structure similar to that of OPP capacitor films. In the case of the films from Comparative Example V2, a surface structure is visible that originates from the PP/COC blended structure. Surface structures of PP/COC blended structures are already known and described in Research Disclosure No. 655030, November 2018.

Temperature Dependence of Dielectric Strength

A test was carried out to determine the dielectric strength according to DIN EN 60243-2 at different temperatures. A single-layer film was used and electrodes with a diameter of 50 mm were employed. The results can be found in Table 2 below.

TABLE 2

| | temperature [° C.] | | | |
|---|---|---|---|---|
| film type | 25 | 100 | 150 | 160 |
| film of | 579 V/μm | 448 V/μm | 288 V/μm | 262 V/μm |
| Example V1 | | | | |
| film of | 577 V/μm | 476 V/μm | 336 V/μm | 323 V/μm |
| Example 2 | | | | |

The dielectric strength is usually determined at room temperature.

Measurements at elevated temperature show that the film of Example 2 used in accordance with the invention had a higher dielectric strength than the standard OPP film.

Long-Term Measurements at Elevated Temperature

Measurements of long-term dielectric strength at elevated temperature under tension were carried out on capacitors made from formulations according to table 1. At the beginning of a series of measurements as well as after intervals of about 250 h, capacitance and dissipation factor were determined at 50 Hz at room temperature, and storage under elevated temperature was continued thereafter.

In a first test, capacitors from Example V1, 3 and 4 were tested.

Tables 3 and 4 below show the temperature profiles and the measurement results.

The test was terminated after failure of all capacitors from example V1.

TABLE 3

| | E-field | | PP-film | PP-COC-film | PP-COC-film |
|---|---|---|---|---|---|
| | strength | temperature | (Example V1) | (Example 3) | (Example 4) |
| time [h] | [V/μm] | [° C.] | capacity [μF]/(% change) | | |
| 0 | | | 6.26 | 6.41 | 6.33 |
| 0-310 | 190 | 90 | 6.22 (−0.6%) | 6.41 (+0%) | 6.33 (+0%) |
| 310-530 | 190 | 120 | 6.18 (−1.3%) | 6.46 (+0.8%) | 6.36 (+0.5%) |
| 530-770 | 190 | 125 | 6.18 (−1.3%) | 6.46 (+0.8%) | 6.36 (+0.5%) |
| 770-1030 | 190 | 130 | 6.14 (−1.9%) | 6.47 (+0.9%) | 6.35 (+0.3%) |
| 1030-1370 | 190 | 130 | 6.07 (−3.0%) | 6.44 (+0.5%) | 6.35 (+0.3%) |
| 1370-1640 | 190 | 133 | failed | 6.40 (−0.1%) | 6.33 (+0.0%) |
| 1640-1900 | 190 | 145 | failed | 6.14 (−4.2%) | 6.26 (−1.1%) |

| | | | |
|---|---|---|---|
| failed units at test end | 3 of 3 | 1 of 3 | 0 of 3 |

TABLE 4

| | E-field | | PP-film | PP-COC-film | PP-COC-film |
|---|---|---|---|---|---|
| | strength | temperature | (Example V1) | (Example 3) | (Example 4) |
| time [h] | [V/μm] | [° C.] | loss factor [*10⁻⁴]/(% change) | | |
| 0 | | | 3.55 | 3.15 | 3.04 |
| 0-310 | 190 | 90 | 3.04 (−14%) | 2.82 (−10%) | 2.81 (−5%) |
| 310-530 | 190 | 120 | 3.74 (5%) | 4.17 (18%) | 3.40 (12%) |
| 530-770 | 190 | 125 | 3.53 (−3%) | 4.01 (13%) | 3.23 (6%) |
| 770-1030 | 190 | 130 | 5.81 (63%) | 4.29 (36%) | 4.21 (38%) |
| 1030-1370 | 190 | 130 | 13.20 (271%) | 4.13 (31%) | 4.18 (38%) |
| 1370-1640 | 190 | 133 | failed | 5.61 (57%) | 4.93 (62%) |
| 1640-1900 | 190 | 145 | failed | 52.5 (1566%) | 6.91 (127%) |

| | | | |
|---|---|---|---|
| failed units at test end | 3 of 3 | 1 of 3 | 0 of 3 |

From the results, it is clear that the capacitors according to the invention exhibit significantly improved stability of properties under the influence of temperature compared with the known OPP capacitors.

In another similar long-term test, capacitors according to Examples V1, 1, 2 and 5 were tested. The capacitors of examples 1, 2 and 5 were produced using PP/COC blends with low COC contents, and 5° C. higher glass transition temperature of the COC.

Tables 5 and 6 below show the temperature curves and the measurement results.

TABLE 5

| | E-field | | PP-film | PP-COC-film | PP-COC-film | PP-COC-film |
|---|---|---|---|---|---|---|
| | strength | temperature | (Example V1) | (Example 1) | (Example 2) | (Example 5) |
| time [h] | [V/μm] | [° C.] | capacity [μF]/(% change) | | | |
| 0 | | | 6.23 | 6.33 | 6.35 | 6.35 |
| 0-250 | 190 | 120 | 6.08 (−2.4%) | 6.33 (0%) | 6.40 (+0.6%) | 6.41 (+0.9%) |
| 250-500 | 190 | 125 | 5.92 (−5.0%) | 6.31 (−0.3%) | 6.39 (+0.8%) | 6.41 (+1.0%) |
| 500-800 | 190 | 130 | 5.09 (−18.3%) | 6.30 (−0.5%) | 6.36 (+0.2%) | 6.41 (+1.0%) |
| 800-1100 | 190 | 135 | failed | 6.25 (−1.3) | 6.32 (−0.5%) | 6.41 (+1.0%) |

TABLE 6

| | E-field | | PP-film | PP-COC-film | PP-COC-film | PP-COC-film |
|---|---|---|---|---|---|---|
| | strength | temperature | (Example V1) | (Example 1) | (Example 2) | (Example 5) |
| time [h] | [V/μm] | [° C.] | loss factor [*10⁻⁴]/(% change) | | | |
| 0 | | | 3.2 | 2.9 | 3.2 | 3.1 |
| 0-250 | 190 | 120 | 5.3 (67%) | 3.7 (28%) | 5.7 (82.5%) | 3.5 (8%) |
| 250-500 | 190 | 125 | 17.9 (465%) | 4.7 (63%) | 6.8 (116%) | 3.6 (15%) |
| 500-800 | 190 | 130 | 102 (3118%) | 5.3 (82%) | 7.1 (124%) | 4.6 (49%) |
| 800-1100 | 190 | 135 | failed | 7.2 (150%) | 7.2 (129%) | 4.6 (47%) |

From the results, it can be seen that capacitors according to Example 2 exhibit increased temperature stability even with low COC contents.

Dielectric Strength of Capacitors in Oil

Dielectric strength tests were carried out on oil-impregnated capacitors. These were wound from the appropriate film and aluminum foil and impregnated with rapeseed oil. The electrode surface area was 2 m². The measurements were made with DC voltage and at room temperature. The measurement results are shown in Table 7 below.

TABLE 7

| film type | dielectric strength [V/μm] |
|---|---|
| OPP-film; Example V1 | 394 |
| PP/COC-film; Example 2 | 394 |

Both the oil-impregnated capacitors made from the known OPP films and capacitors made from the films used in the invention showed the same dielectric strength.

1. A capacitor comprising as dielectric a biaxially stretched film comprising a blend of polypropylene and cycloolefin polymer, with the proviso that the proportion of cycloolefin polymer in the blend is between 3 and 18% by weight.

2. The capacitor according to claim 1, wherein the proportion of cycloolefin polymer in the blend is between 3 and 14% by weight.

3. The capacitor according to claim 2, wherein the proportion of cycloolefin polymer in the blend is between 6 and 12 wt. %.

4. The capacitor according to claim 3, wherein the proportion of cycloolefin polymer in the blend is between 7 and 9 wt. %.

5. The capacitor according to claim 1 wherein the biaxially stretched film shows no phase structure in scanning electron microscopic examination after 24-hour treatment with cyclohexane at room temperature.

6. The capacitor according to claim 1, wherein the biaxially stretched film exhibits a surface structure without fibrils when examined under a light microscope.

7. The capacitor according to claim 1, wherein the cycloolefin polymer is a cycloolefin copolymer.

8. The capacitor according to claim 1, wherein the cycloolefin polymer has a glass transition temperature between 130 and 170° C.

9. The capacitor according to claim 1, wherein the cycloolefin polymer is a cycloolefin copolymer consisting of structural units derived from ethylene and norbornene.

10. The capacitor according to claim 1, wherein polypropylene is a propylene homopolymer or a propylene copolymer with a crystallite melting temperature between 100 and 170° C.

11. The capacitor according to claim 1, wherein the polypropylene is a capacitor-grade polypropylene.

12. The capacitor according to claim 1, wherein the biaxially oriented film is metallized.

13. The capacitor according to claim 1, wherein the biaxially oriented film contains no additives.

14. The capacitor according to claim 1, wherein a total content of trace metals of iron, cobalt, nickel, titanium, molybdenum, vanadium, chromium, copper, magnesium and aluminum in the biaxially stretched film is less than 10 ppm.

15. The capacitor according to claim 1, wherein the biaxially oriented film has a thickness of between 0.5 and 20 μm, measured according to DIN 53370.

16. A method for manufacturing capacitors utilizing a biaxially stretched film comprising a mixture of polypropylene and from 3 to 18% by weight of cycloolefin polymer as a dielectric, the percentage being based on the total amount of the mixture.

17. The method according to claim 16, wherein a biaxially oriented film is used which, after treatment with cyclohexane at room temperature for 24 hours, shows no phase structure in scanning electron microscopic examination and which, in light microscopic examination, shows a surface structure without fibrils.

18. The capacitor according to claim 8, wherein the glass transition temperature is between 140 and 160° C.

19. The capacitor according to claim 18, wherein the glass transition temperature is greater than 145° C. to 160° C.

20. The capacitor according to claim 10 wherein the polypropylene comprises a semi crystalline polypropylene with a melting temperature between 100 and 170° C.
